(19) United States
(12) Patent Application Publication
(10) Pub. No.: US 2016/0035245 A1
(43) Pub. Date: Feb. 4, 2016

(54) Method and Educational Tool for Teaching Vocational Skills to People with Autism

(71) Applicant: Matthew Jason Ratz, North Potomac, MD (US)

(72) Inventor: Matthew Jason Ratz, North Potomac, MD (US)

(21) Appl. No.: 14/449,712

(22) Filed: Aug. 1, 2014

(51) Int. Cl. G09B 19/00

(52) U.S. Cl. CPC G09B 19/00

(57) ABSTRACT

The method involves teaching vocational skills to people with autism via facilitated, repeated hands-on practice. The method may include the system for analyzing the steps of a target vocational skill and the collecting the physical materials necessary to practice that skill in a hands-on fashion. The invention further includes collection of these required materials into a storage container along with an instructional card that includes both verbal and visual step-by-step procedures illustrating the completion of the vocational task. The invention further includes the design of a chart, graph or grading scale that enables individual mastery to be charted.

### TECHNICAL FIELD

The present invention may be in the technical field of Educational or Demonstration. More particularly, the present invention may be in the technical field of Occupation and/or the technical field of Means for Displaying Education Material. More particularly, the present invention may be in the technical field of Demonstration or display means combined with storage or collection means. More particularly, the present invention may be a method and/or an educational tool for teaching an array of vocational and occupational skills to adults with autism.

### BACKGROUND OF THE INVENTION

Conventional methods for the teaching of vocational skills—namely verbal instructions by a supervisor, visual modeling by a colleague, or simulated role-playing—fail to prove effective for the training of people with autism. People with autism affected by this developmental disability experience difficulty generalizing and extrapolating from one skill set to a novel-but-related skill set; additionally, many people with autism lack the cognitive skills for advanced and independent critical reasoning which are required for many worksite tasks (for example, loading a document face-down into a copy machine may be experienced as a task completely separate from hitting the “Copy” button to initiate a photocopy in the same machine).

As a result, for people autism, each specific task or skill to be learned must be simulated and practiced repeatedly on its own before being linked to further tasks; through this method, the majority of people with autism can develop expertise on particular skill sets without being limited by their developmental disability's manifestations.

In terms of an effective training method, while children in school are often presented with manipulative instruments to help them build complex skills, few such methods have been widely available for adults, especially adults with autism, to teach them workplace skills.

### SUMMARY OF THE INVENTION

The present invention may be a method and an educational tool for the teaching of an array of vocational skills to adults with autism through the use of physical materials for hands-on, simulated, and repeated practice along with both the written and visual instructions necessary for a task's completion and a graph or chart to record progress toward mastery, all contained within a suitably-durable container for storing these materials and instructions.

### BRIEF DESCRIPTION OF THE DRAWINGS

FIG. 1 is a top view of the present invention;

FIG. 2 is a side perspective view of FIG. 1;

FIG. 3 is a front view of FIG. 1;

FIG. 4 is a representation of the layout of an instructional card included in FIG. 1 to FIG. 3.

### DETAILED DESCRIPTION OF THE INVENTION

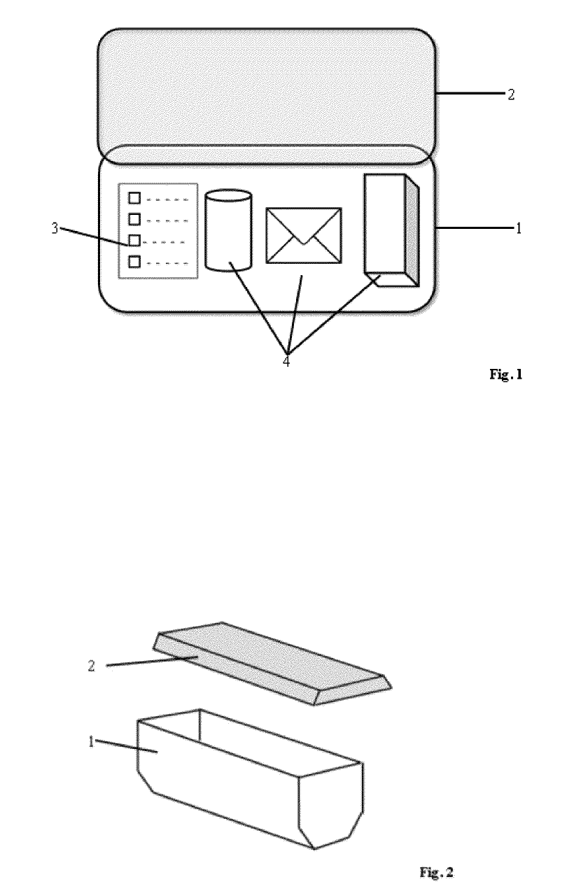

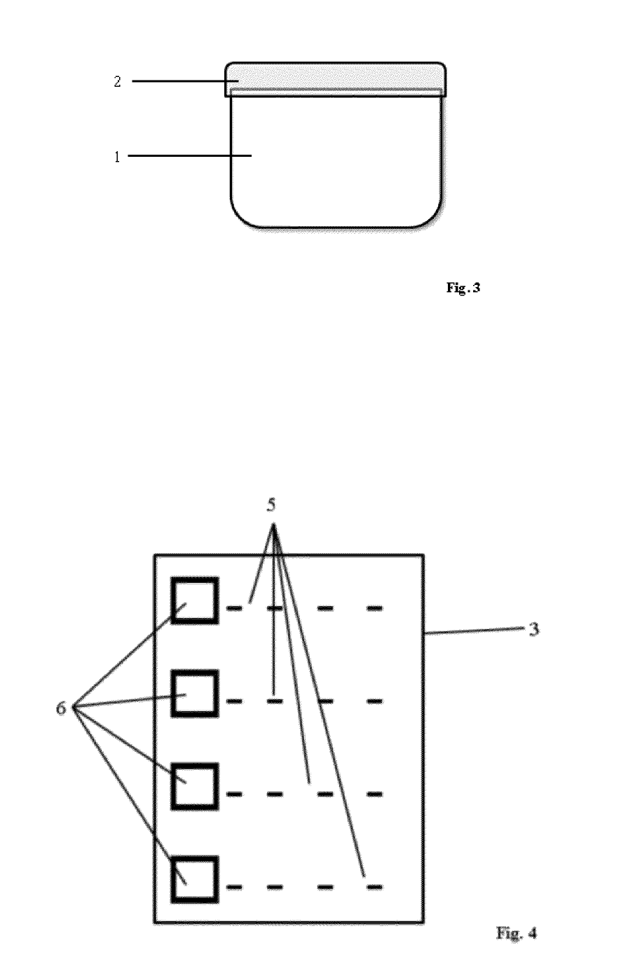

Referring now to the invention in more detail; in FIG. 1 to FIG. 4, there is shown a container 1 with a lid 2 that contains an instructional card 3 and a variety of materials necessary to practice the target vocational skill 4.

In more detail, still referring to the invention in FIG. 1 to FIG. 4, the container 1 and its lid 2 can be either transparent or opaque, and the variety of materials inside 4 may represent the full-scale elements for completing a targeted vocational task. For example, if the targeted task is to prepare an envelope for mailing, the included materials will be comprised of: an envelope that should be the standard, #10 size; a letter that should be printed on size A4 paper and should be folded in the standard tri-fold method; “to” and “from” labels should be reproduced in a standard size; simulation postage stamps should be reproduced in standard size; a scale capable of weighing an envelope in ounces or grams should be provided; and a postage chart converting the mail's weight to a price for postage should be produced to correspond with actual postage rates across the US.

If, as another example, the targeted vocational skill is fulfilling customers' orders of books and magazines, then the material 4 should be comprised of: envelopes or mailing boxes of the appropriate size, pre-printed with a plurality customers' names and addresses; the assortment of books and magazines being ordered by a plurality of customers; and packing slips of a plurality of customers' orders to be collated into individual orders which will be placed into the envelopes.

The specific material contents of the container 4 and the instructional card 3 (and FIG. 4)—containing both written text 5 and visual instructions 6—will vary based on the targeted vocational task being practiced. While those of ordinary skill may be able to make and use a method similar in elements to the method and educational tool described above, those of ordinary skill will understand and appreciate the existence of variations, combinations, and equivalents of the specific embodiment, method, and examples herein.

In further detail, still referring to the invention in FIG. 1 to FIG. 4, the included materials 4 represent the items listed and included on the instructional card 3 (detailed in FIG. 4). The instructional card includes both written, step-by-step instructions 5 written in easy-to-follow language as well as visual directions 6 walking learners, step-by-step, through each required step in the overall task's process through completion. The images accompanying the written instructions support non-literate individuals' successful completion of the task, as some people with autism are non-literate.

Written instructions 5 include simples sentences composed of clear verbs and easy-to-follow procedures (e.g. “Step 1. Place the folded letter into the envelope so that the flap can close fully. Step 2. Seal the flap by wetting its gummed section. Step 3. Place the TO label on the front of the envelope, in the center.” etc.) and the visual instructions 6 may include photographic representations of what the process will look like from beginning to end (e.g. an envelope with a folded letter inserted fully inside of it so that the envelope's flap can close fully, an envelope's gummed section being wetted and sealed, the proper location of a TO label on an envelope's front, etc.).

The construction details of the invention as shown in FIG. 1 to FIG. 4 may be a container 1 and lid 2, or other conveyable such as a bin or bag made of plastic, vinyl, acrylic, or other light-weight, non-breakable material to prevent accidental damage or purposeful attempts at dismantling or destroying the container as these attempts may occur from time to time through regular use by people with autism. As a symptom of their disability, people with autism may fail to recognize how their strength, when applied to an object, may break or damage that object. The construction will include, further: laminated paper, cardstock, or cardboard for the instructional card 3 whose contents are composed by the inventor in the above-stated, comprehensible language, having been laid out and published via a word processing or similar desktop publishing application that allows for the inclusion of photographs of appropriate size, quality, and clarity alongside the text; and the materials required for the completion of the vocational task 4 which should be the actual items—or full-scale representations thereof—that will be used on the job including both the items described in the paragraphs above and other materials such as: PVC piping; steel shut-off valves; A4 documents for mailing and/or filing and collating; an assortment of shopping hangers for sorting by type; assorted articles of clothing for matching; aluminum cans and plastic bottles for recycling; toiletries and travel bags for sorting; or any other items essential for the completion, by a person with autism, of a targeted vocational task that advances his or her professional skill in a specific industry.

The advantages of the present invention include, without limitation, the ability for people with autism as well as instructional support staff who may assist them to have both written and visual step-by-step procedures for the completion of vocational tasks which will enable learners to complete tasks more accurately and consistently; the opportunity to practice and perfect an array of vocational skills via appropriately broken-down processes through the use of and trial with full-scale materials that are the actual materials necessary of the task or that are represented in a form as close to “real” as can be readily procured; and a container whose durability can withstand both accidental drops and/or purposeful attempts at destruction or dismantling that may occur with the given population.

In broad embodiment, the present invention may be a method or an educational tool for teaching vocational skills to adults with autism through the use of physical materials for hands-on practice as well as the instructions—represented verbally and visually—necessary for a task's completion and the container in which the necessary items are stored.

While the forgoing written description of the invention may enable one of ordinary skill to make and use what may be considered presently to be the best mode thereof, those of ordinary skill will understand and appreciate the existence of variations, combinations, and equivalents of the specific embodiment, method, and examples herein. The invention should therefore not be limited by the above-described embodiment, methods, and examples, but by all embodiments and methods within the scope and spirit of the invention.

I claim:

1. A method and educational tool for teaching vocational skills to adults with autism comprised of: the break-down of a particular vocational task into its composite steps; the identification and procurement of the physical materials of the vocational task for hands-on practice; an instructional card with the step-by-step instructions necessary for a task's completion; a non-breakable container or a container of suitable durability in which the necessary items may be stored; and a tool such as a chart, graph, or grading scale for measuring an individual's progress toward mastery of the task.

2. The break-down of a particular vocational task into its composite steps is comprised of: understanding how the isolated task fits in to the larger vocational field (e.g. how the preparation of silverware rolls ahead of a restaurant's opening enables that restaurant to quickly seat and serve customers when open for business); and an understanding of the specific steps essential for consistently and efficiently completing the task that can be easily replicated once mastered.

3. A method of claim 2 further comprising: a method by which the goal inherent in a vocational task can be identified by the inventor (e.g. the employee will apply the proper postage to a letter to be mailed in order that letter mailed by a business will arrive at their needed locations without delay).

4. A method of claim 2 further comprising: a method of analysis, by the inventor, of essential versus non-essential steps of the task so that redundant or non-essential steps can be reduced or eliminated thereby increasing the person with autism's likelihood of achieving mastery of the task in a given timeframe (i.e. 12 months).

5. A method of claim 1, namely “The physical materials for hands-on practice” are comprised of: the materials—or full-scale replicas thereof—essential to the successful completion of the targeted vocational task and in quantities sufficient to support repeated practice as determined by the inventor.

6. A method of claim 5 further comprising: identifying and procuring the material items necessary for the completion of an isolated vocational task directly from or in conjunction with the industry to which the task belongs (e.g. if the task involves sorting toothbrushes and mouthwash into carry-out baggies for dental offices, the materials will be procured from professional dentists or purchased from retail stores).

7. A method of claim 5 further comprising: a method by which the minimum number of repetitions necessary for individual mastery of a vocational skill can be assessed and progress toward mastery can be recorded either by the individual practicing the skill or by the instructional staff supporting him or her.

8. A method of claim 7 comprising a reproducible chart, graph, or grading scale that aligns each step of the vocational task alongside rankings (such as “Completed Independently,” “Verbal Guidance Required,” “Hands-on Assistance Required,” etc.) so that individuals or assigned instructional staff can measure an individual's progress toward mastery.

9. A method of claim 1, namely “The instructions necessary for a task's completion” are comprised of: written, step-by-step instructions; and photographic or illustrated step-by-step instructions that accompany and enhance a person of ordinary skill's comprehension of the writing.

10. A method of claim 9 further comprising: clear, easily-understood, and easily-actionable written instructions for completing the task composed in Standard Written English and typed in a font size easily deciphered without the use of visual aids by a person of ordinary skill. (e.g. “Step 1. Fold a napkin diagonally so it makes a triangle. Step 2. Pick up the fork and place it along the longest edge of the napkin. Step 2. Pick up the knife and place it directly next to the fork at the edge of the napkin.” etc.)

11. A method of claim 9 further comprising: photographic images of appropriate size, quality, and clarity that effectively demonstrate how each completed step of the task should look so that someone unfamiliar with the task can mimic the images through his or her own actions and successfully complete the task.

12. A method of claim 9 further comprising: a single-page document appropriately spaced and laid-out so that all instructions fit on a single side of the document and so that the instructional card can be laminated for durability.

13. A method of claim 1, namely “A non-breakable container or a container of suitable durability” is comprised of: a box, bin, bag, or other storage mechanism made of plastic, acrylic, vinyl, or equally-non-breakable and/or durable material and that can be sealed either by a lid or some other mechanism such as a zipper top or hook-and-loop enclosure to keep the materials therein contained.

14. A method of claim 13 further comprising: an array of options for storage of different shapes, sizes, and weights so that the long-term storage of instructional materials can be varied based on the variance of the required materials and on the particular needs of the person or persons with autism using the materials.
